(19) United States
(12) Patent Application Publication
(10) Pub. No.: US 2024/0181384 A1
(43) Pub. Date: Jun. 6, 2024

(54) OXYGEN ABSORBING COMPOSITION AND METHOD OF MANUFACTURING THEREOF

(71) Applicant: DESICCARE, INC., Las Vegas, NV (US)

(72) Inventor: Sammie Joe Glorioso, Ridgeland, MS (US)

(21) Appl. No.: 18/527,153

(22) Filed: Dec. 1, 2023

Related U.S. Application Data
(60) Provisional application No. 63/385,850, filed on Dec. 2, 2022.

(51) Int. Cl. B01D 53/18; B01J 20/04; B01J 20/14; B01J 20/16; B01J 20/20; B01J 20/24; B01J 20/32

(52) U.S. Cl. CPC B01D 53/18; B01J 20/04; B01J 20/14; B01J 20/165; B01J 20/20; B01J 20/24; B01J 20/3291; B01D 2252/504; B01D 2257/104; B01J 2220/46; B01J 2220/62

(57) ABSTRACT

An oxygen absorbing element including a sealed sachet containing an oxygen absorbing composition, wherein the oxygen absorbing composition includes iron and carbon. The oxygen absorbing composition may also include glycerin, zeolite, salt, and water. The oxygen absorbing composition may also include diatomaceous earth, salt, and water.

### CROSS-REFERENCE TO RELATED APPLICATION(S)

This application claims priority to and the benefit of U.S. Provisional Application No. 63/385,850, filed on Dec. 2, 2022, the entire contents of which is incorporated herein by reference.

### BACKGROUND

### 1. Field

The present disclosure relates generally to the field of oxygen control. The present disclosure also relates generally to the field of an oxygen absorbing composition and a method of manufacturing thereof.

### 2. Description of the Related Art

Oxygen control products in general are well known. The control of oxygen in an environment may be desirable for various products, such as food and pharmaceuticals, in order to improve the shelf-life of the product, prevent growth of aerobic microorganisms, and prevent pharmaceuticals from being affected by moisture. Oxygen control products are also used in the medical industry, for example, for blood storage (e.g., for blood transfusions). In particular, anaerobic storage (e.g., storage free from oxygen) can enhance the metabolic status of red blood cells.

Typical oxygen absorbers (or oxygen scavengers) use oxidation of iron or a similar metal to reduce oxygen in an environment, and require water to activate. Additionally, typical oxygen absorbers may be contained in packages such as sachets. However, common oxygen absorbers, such as those that use vermiculite as a carrier, may lose water through evaporation over time. This loss of water may lead to loss of oxygen absorbing functionality. Further, the need to include vermiculite in addition to the oxygen absorbing elements means larger oxygen absorbing sachets are required to package the vermiculite together with the oxygen absorbing composition. Also, the vermiculite-based compounds may have higher exothermal reactions that can cause condensation within the packaging, which can damage packaging.

New oxygen absorbing compounds and packaging that require less space can allow for more efficient uses of resources such as storage space, transportation, packaging material, and manufacturing space and also improve the overall performance of oxygen control products. Additionally, new oxygen absorbing composition with lower exothermal reactions can reduce condensation and reduce damage to packaging.

### SUMMARY

Aspects according to one or more embodiments of the present disclosure are directed toward an oxygen absorbing composition that is less exothermal and less reactive with oxygen in the atmosphere.

Aspects according to one or more embodiments of the present disclosure are directed toward an oxygen absorbing composition that can allow for smaller packaging and more efficient uses of resources such as storage space, transportation, and packaging material.

Additional aspects will be set forth in part in the description which follows and, in part, will be apparent from the description, or may be learned by practice of the presented embodiments of the present disclosure.

According to some example embodiments of the present disclosure, an oxygen absorbing element including a sealed sachet containing an oxygen absorbing composition, wherein the oxygen absorbing composition includes iron and carbon.

According to some example embodiments, the oxygen absorbing composition further includes glycerin and zeolite.

According to some example embodiments, the oxygen absorbing composition further includes salt and water.

According to some example embodiments, the oxygen absorbing composition includes about 30-50% by weight of iron, about 5-20% by weight of zeolite, about 5-10% by weight of glycerin, about 5-25% by weight of carbon, about 3-7% by weight of salt, and about 4-20% by weight of water.

According to some example embodiments, the salt includes at least one selected from among sodium chloride (NaCl), potassium chloride (KCl), sodium nitrate (NaNO₃), potassium sulfate (KS₂O₄), and potassium perchlorate (KClO₄).

According to some example embodiments, the carbon includes at least one selected from among lignite carbon and 325 mesh carbon.

According to some example embodiments, the iron includes at least one selected from among sponge iron and 325 mesh iron.

According to some example embodiments, the glycerin is a liquid glycerin.

According to some example embodiments, the oxygen absorbing composition includes about 50% by weight of iron, about 5% by weight of glycerin, about 25% by weight of zeolite, and about 20% by weight of carbon.

According to some example embodiments, the oxygen absorbing composition further includes diatomaceous earth.

According to some example embodiments, the oxygen absorbing composition further includes salt and water.

According to some example embodiments, the oxygen absorbing composition includes about 30-50%% by weight of iron, about 10-30% by weight of diatomaceous earth, about 5-20% by weight of carbon, about 3-7% by weight of salt, and about 4-20% by weight of water.

According to some example embodiments of the present disclosure, a method for manufacturing an oxygen absorbing element including a sealed sachet using a packaging machine including a container and a turntable, the method including: preparing an oxygen absorbing composition; adding the oxygen absorbing composition to the container over a turntable, the container being configured to deposit a measured amount of the oxygen absorbing composition; depositing the oxygen absorbing composition into a sachet on the turntable using the container; depositing water to the oxygen absorbing composition in the sachet using a water pump; and sealing the sachet using the packaging machine.

According to some example embodiments, the oxygen absorbing composition includes iron, carbon, glycerin, and zeolite.

According to some example embodiments, the oxygen absorbing composition further includes salt.

According to some example embodiments, the oxygen absorbing composition includes about 50% by weight of iron, about 5% by weight of glycerin, about 25% by weight of zeolite, and about 20% by weight of carbon.

According to some example embodiments, an amount of water deposited is 0-20% by weight of the oxygen absorbing composition.

According to some example embodiments, an amount of water deposited is 14-20% by weight of the oxygen absorbing composition.

According to some example embodiments, the glycerin is a liquid glycerin.

According to some example embodiments, the liquid glycerin is added to the iron before they are added to the carbon and the zeolite of the oxygen absorbing composition.

According to some example embodiments, the iron is added to the zeolite before they are added to the glycerin and carbon.

According to some example embodiments, the oxygen absorbing composition includes iron, carbon, and diatomaceous earth.

According to some example embodiments of the present disclosure, oxygen absorbing composition includes about 30-50% by weight of iron, about 5-20% by weight of Zeolite, about 5-10% by weight of glycerin, about 5-25% by weight of carbon, about 3-7% by weight of salt, and about 4-20% by weight of water.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a flowchart showing a method for manufacturing sachets with an oxygen absorbing composition, in accordance with example embodiments of the disclosure; and

FIG. 2 is a table of temperature measurements of a sachet containing an oxygen absorbing composition, in accordance with example embodiments of the disclosure.

FIG. 3 is a schematic diagram of the packaging machine, in accordance with example embodiments of the disclosure.

### DETAILED DESCRIPTION

Features of the inventive concept and methods of accomplishing the same may be understood more readily by reference to the following detailed description of embodiments and the accompanying drawings. Hereinafter, embodiments will be described in more detail with reference to the accompanying drawings. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. Further, parts not related to the description of the embodiments might not be shown to make the description clear. In the drawings, the relative sizes of elements, layers, and regions may be exaggerated for clarity.

In the following description, for the purposes of explanation, numerous specific details are set forth to provide a thorough understanding of various embodiments. It is apparent, however, that various embodiments may be practiced without these specific details or with one or more equivalent arrangements.

The terminology used herein is for the purpose of describing particular embodiments only and is not intended to be limiting of the present invention. As used herein, the singular forms “a” and “an” are intended to include the plural forms as well, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively. Also, the term “exemplary” is intended to refer to an example or illustration.

When a certain embodiment may be implemented differently, a specific process order may be performed differently from the described order. For example, two consecutively described processes may be performed substantially at the same time or performed in an order opposite to the described order.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Embodiments of the present disclosure are described below.

The present disclosure is directed to one or more embodiments of an oxygen absorbing element containing an oxygen absorbing composition. The oxygen absorbing element may include a package (e.g., a sachet or other container) containing the oxygen absorbing composition. In some embodiments, the oxygen absorbing composition may include a mixture (e.g., a powder mixture) of iron (Fe), carbon (C), glycerin (e.g., liquid glycerin), zeolite (e.g., 99% purity zeolite), salt, and water. In other embodiments, the oxygen absorbing composition may include a mixture (e.g., a powder mixture) of iron, diatomaceous earth, carbon, salt, and water. In some embodiments, a powder mixture of iron, carbon, glycerin, and zeolite may be prepared and stored before adding salt, water, or a combination thereof. In some embodiments, the glycerin may be in a liquid form and added to iron before the iron is added to the powder mixture. In other embodiments, a powder mixture of iron, carbon, and diatomaceous earth may be prepared and stored before adding salt, water, or a combination thereof.

The oxygen absorbing composition disclosed herein differs from comparable oxygen absorbing compositions (e.g., compositions that include vermiculite) because it requires smaller amounts of the composition in the sachets, which, thus, allows for smaller sachets that require less storage space. In addition, when compared to comparable oxygen absorbing compositions, the oxygen absorbing composition disclosed herein is less exothermal and is less reactive with oxygen in the atmosphere before the oxygen absorbing composition is sealed in the package. The slower reaction with oxygen allows the oxygen absorbing composition to absorb oxygen over a longer period of time and prolong the effectiveness of the composition. Also, the lower exothermal properties of the composition reduce the likelihood of condensation within the package, which can damage the products stored with the package.

In some embodiments, about 30-50%% by weight of the oxygen absorbing composition may be composed of iron, about 10-30% by weight of the composition may be composed of diatomaceous earth, about 5-20% by weight of the composition may be composed of carbon, about 3-7% by weight of the composition may be composed of salt, and about 4-20% by weight of the composition may be composed of water.

In other embodiments, about 30-50% by weight of the oxygen absorbing composition may be composed of iron, about 5-20% by weight of the composition may be composed of zeolite, about 5-10% by weight of the composition may be composed of glycerin, about 5-25% by weight of the composition may be composed of carbon, about 3-7% by weight of the composition may be composed of salt, and about 4-20% by weight of the composition may be composed of water.

One or more suitable types of carbon may be used in the oxygen absorbing composition. For example, the carbon may be lignite carbon. In another example, the carbon may be 325 mesh carbon. Similarly, one or more suitable types of iron may be used in the composition. For example, the iron may be sponge iron (e.g., hydrogen-reduced sponge iron and water-atomized iron). In a preferred embodiment, the iron may be 325 mesh iron.

The salt used in the oxygen absorbing composition may include sodium chloride (NaCl), potassium chloride (KCl), sodium nitrate (NaNO₃), potassium sulfate (KS₂O₄), potassium perchlorate (KClO₄), or other salts. A salt that does not contain iodine is preferred. The salt may be powdered or granulated.

In some embodiments, a mixture (e.g., a powder mixture) of iron, carbon, glycerin (e.g., liquid glycerin), and zeolite may be prepared and stored before adding salt, water, or a combination thereof. In some embodiments, the glycerin may be in a liquid form and added to iron before the iron is added to the powder mixture. The powder mixture may be less reactive with oxygen in the atmosphere and can be stored longer than a composition that includes salt and/or water. In some embodiments, before salt and water is added to the powder mixture, about 50% by weight of the powder mixture may include iron, about 5% by weight of the powder mixture may include glycerin, and about 25% by weight of the powder mixture may include zeolite, and about 20% by weight of the powder mixture may include carbon.

In some embodiments, the amount of salt included in the powder mixture may be about 0-2% by weight of the powder mixture before salt and water is added. For example, if the weight of iron, glycerin, zeolite, and carbon in the powder mixture is 100 grams, then about 0-2 grams of salt will be added to the powder mixture. In some embodiments, the salt may be impregnated on the carbon used in the powder mixture. In other embodiments, the salt may be blended with water to a suitable concentration and then added to the powder mixture along with the water.

In some embodiments, a mixture (e.g., a powder mixture) of iron, carbon, and diatomaceous earth may be prepared and stored before adding salt, water, or a combination thereof. The powder mixture may be less reactive with oxygen in the atmosphere and can be stored longer than a composition that includes salt and/or water.

In some embodiments, before salt and water is added to the powder mixture, about 5-20% by weight of the powder mixture may include diatomaceous earth, about 35-50% by weight of the powder mixture may include carbon, and about 35-50% by weight of the powder mixture may include iron. In some embodiments, about 5-30% by weight of the powder mixture of water and about 5-30% by weight of the powder mixture of salt may be added subsequently added.

In some embodiments, the weight of the powder mixture may be about 12 grams before salt and water are added to the powder mixture.

According to one or more embodiments, the oxygen absorbing composition may be contained in a package such as a sachet or other container. In some embodiments, sachets containing the oxygen absorbing composition can be manufactured using a packaging machine (e.g., a MC-101 machine from Sanko Machinery). The packaging machine may be configured to add the oxygen absorbing composition into the sachet and seal the sachet. In some embodiments, the packaging machine may seal the sachets in a nitrogen atmosphere.

A single sachet containing the oxygen absorbing composition may be able to remove about 1200 to 1400 cubic centimeters in volume of oxygen over a 24 hour time period. In some embodiments, the length of the sachet may be about 57 millimeters to 63 millimeters and the width of the sachet may be about 78 millimeters to 82 millimeters.

In some embodiments, a water pump (e.g., HiBar Pump/Model No. 2BC-20-341) may be connected to the packaging machine. The water pump may be configured to deposit a precise amount of water into the sachet. For example, the water may be configured to deposit small volumes of water of up to 20 cc or from about 0.02 mL to about 20 mL per shot of the pump.

In some embodiments, the packaging machine may include a container (e.g., a hopper) positioned over one or more turntables. The powder mixtures disclosed previously may be placed in the container and empty sachets can be positioned on the turntables. For example, a powder mixture of iron, carbon, and diatamecous earth may be added to the container, or a powder mixture of iron, carbon, glycerin (e.g., liquid glycerin), and zeolite may be added to the container. The container can be configured to deposit a measured amount of the powder mixture into the sachets positioned on the turntables.

Subsequently, water may be added to the powder mixture using the water pump. The water is absorbed by the powder mixture. The water may be added to the powder mixture after the powder mixture is placed into the sachets and before the sachet is sealed. In some embodiments, the amount of water added to the powder mixture may be about 0-6% by weight of the powder mixture before salt and water is added. In some embodiments, the amount of water added to the powder mixture may be about 5-30% by weight of the powder mixture before salt and water is added. In some embodiments, the water may be deionized (DI) water and/or purified water. A neutral pH (e.g., a pH of about 7) is preferred. The sachet with the oxygen absorbing composition may then be sealed to form the oxygen absorbing element.

After preparing the oxygen absorbing element, the oxygen absorbing element can be stored in a nitrogen cabin (e.g., a cabin filled with nitrogen gas). The oxygen percentage in the nitrogen cabin may be as close to 0% by volume as possible. In some embodiments, the sachets may be stored by vacuum sealing the sachets in a barrier bag using a sealer (e.g., a packaging machine from ULMA).

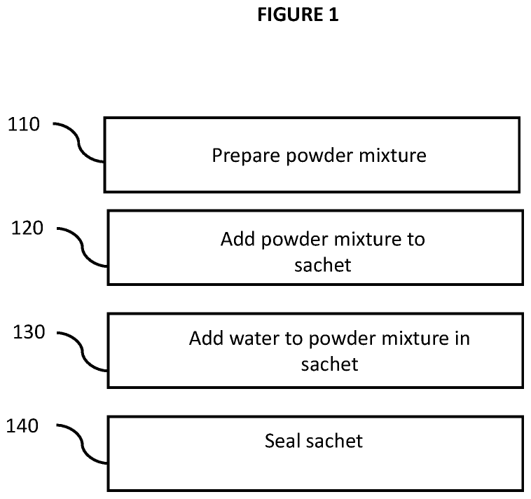

FIG. 1 is a flowchart showing a method for manufacturing sachets with an oxygen absorbing composition, in accordance with example embodiments of the disclosure. According to some example embodiments, the number and order of operations illustrated in FIG. 1 may vary. For example, according to some example embodiments, there may be fewer or additional operations, unless otherwise stated or implied to the contrary. Additionally, the order of the operations may vary, unless otherwise stated or implied to the contrary.

The method for manufacturing sachets containing oxygen absorbing composition may begin with preparing a powder mixture in step 110. In some embodiments, the powder mixture may include iron, carbon, glycerin, and zeolite. In some embodiments, the glycerin may be in a liquid form and added to iron before the iron is added to the powder mixture. In some embodiments, about 50% by weight of the powder mixture may include iron, about 5% by weight of the powder mixture may include glycerin, and about 25% by weight of the powder mixture may include zeolite, and about 20% by weight of the powder mixture may include carbon.

Additionally, the components of the powder mixture may be added at various times. For example, iron and carbon may be added to the mixture first in some embodiments (e.g., added together before added to the remaining components of the powder mixture), while iron and zeolite may be added first in other embodiments (e.g., added together before added to the remaining components of the powder mixture). Further, each of the components may be added in one or more forms, including, but not limited to, a powder form or a liquid form.

In some embodiments, the powder mixture may include iron, carbon, and diatomaceous earth. In some embodiments, about 5-20% by weight of the powder mixture may include diatomaceous earth, about 35-50% by weight of the powder mixture may include carbon, and about 35-50% by weight of the powder mixture may include iron.

In step 120, the powder mixture may be added to empty sachets. In embodiments, the powder mixture can be added to the empty sachets using a container positioned over one or more turntables. For example, the powder mixture may be placed in the container while the empty sachets are positioned on the turntables. The container can be configured to deposit a measured amount of the powder mixture into the sachets positioned on the turntables.

In step 130, water may be added to the powder mixture. In some embodiments, water may be added to the powder mixture using a water pump (e.g., HiBar Pump/Model No. 2BC-20-341). The water pump may be configured to deposit a precise amount of water into the sachet. In some embodiments, the amount of water added to the powder mixture may be about 0-20% by weight of the powder mixture. In one embodiment, the amount of water added may be about 14-20% of the weight of the powder mixture. In one embodiment, the amount of water added may be about 5-30% by weight of the powder mixture. In some embodiments, the water may be deionized (DI) water and/or purified water. A neutral pH (e.g., a pH of about 7) is preferred.

In step 140, the sachet is sealed. In some embodiments, the sachets may be sealed using a packaging machine (e.g., a MC-101 machine from Sanko Machinery). In some embodiments, the packaging machine may seal the sachets in a nitrogen atmosphere.

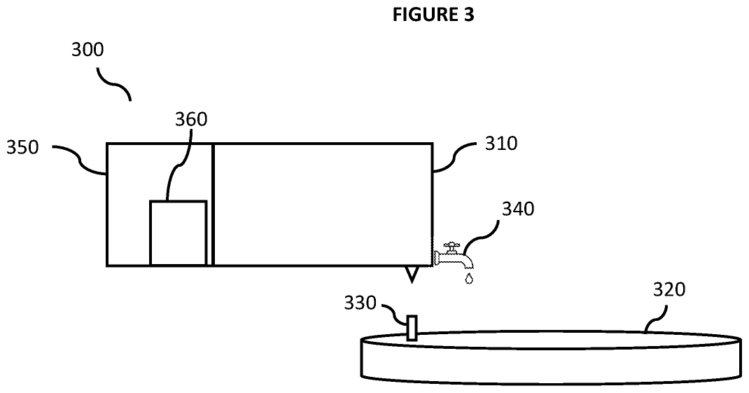

FIG. 3 is a schematic diagram of the packaging machine, in accordance with example embodiments of the disclosure.

As shown in FIG. 3, the packaging machine 300 may have a container 310 positioned over one or more turntables 320. One or more sachets 330 may be positioned on the turntable 320. The container 310 may be configured to hold a mixture of the oxygen absorbing composition and may be configured to deposit a measured amount of the mixture into the sachets 330 on the turntable 320.

In some embodiments, the packaging machine 300 may include a water pump 340 connected to the packaging machine 300. The water pump 340 may be configured to deposit a precise amount of water into the sachet 330. In some embodiments, the water pump may be a HiBar Pump/Model No. 2BC-20-341.

In some embodiments, the packaging machine 300 may also include a nitrogen cabin 350 (e.g., a cabin filled with nitrogen gas). The oxygen percentage in the nitrogen cabin may be as close to 0% by volume as possible. The nitrogen cabin 350 may also include a sealer 360. After the oxygen absorbing composition and water have been added to the sachets 330, the sachets 330 may be sealed in the nitrogen cabin 350 using the sealer 360.

### Example 1

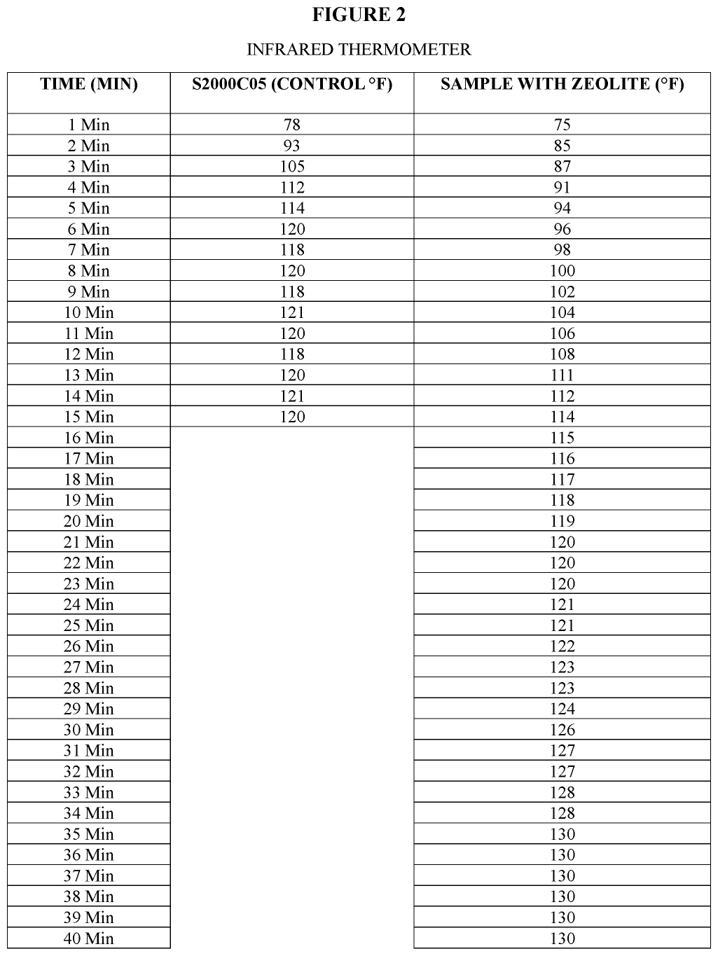

A sachet product containing an oxygen absorbing composition was prepared according to the embodiments disclosed herein. The heat produced by the sachet product was measured over a period of time. In Example 1, oxygen absorbing composition included 30-50% by weight of the mixture of iron, 10-30% by weight of the mixture of diatomaceous earth, 5-20% by weight of the mixture of carbon, 3-7% by weight of the mixture of salt, and 4-20% by weight of the mixture of water. The oxygen absorbing composition was mixed and immediately sealed in the sachet using the MC-101 machine. After sealing, the temperature of the sachet containing the oxygen absorbing composition was measured once a minute using a thermometer (Manufacturer: Wika/Model TG-53). The results of the measurements are included in FIG. 2. As shown by the results in FIG. 2, the exothermic reaction of the components of the oxygen absorbing composition increased the temperature of the sachet to 120 degrees Fahrenheit after 15 minutes.

### Example 2

Another sachet product containing a different oxygen absorbing composition was prepared according to the embodiments disclosed herein. The heat produced by the sachet product was measured over a period of time. In Example 2, the oxygen absorbing composition included 30-50% by weight of the mixture of iron, 5-20% by weight of the mixture of zeolite, 5-10% by weight of the mixture of glycerin, 5-25% by weight of the mixture of carbon, 3-7% by weight of the mixture of salt, and 4-20% by weight of the mixture of water. The oxygen absorbing composition was mixed and immediately sealed in the sachet using the MC-101 machine. After sealing, the temperature of the sachet containing the oxygen absorbing composition was measured once a minute using a thermometer (Manufacturer Wika/Model TG-53). The results of the measurements are included in FIG. 2. As shown in the results in FIG. 2, the exothermic reaction of the components of the oxygen absorbing composition increased the temperature of the sachet to 120 degrees Fahrenheit after 23 minutes. Further, the temperature increased until it was maintained at 130 degrees Fahrenheit for 6 minutes. The data shows that the oxygen absorbing compositions in Examples 1 and 2 increased temperature at a slower rate than comparable oxygen absorbing compositions used in the art (e.g., oxygen absorbing compositions including vermiculite).

While this disclosure has been described in detail with particular references to some exemplary embodiments thereof, the exemplary embodiments described herein are not intended to be exhaustive or to limit the scope of the disclosure to the exact forms disclosed. It is understood that the drawings are not necessarily to scale. Persons skilled in the art and technology to which this disclosure pertains will appreciate that alterations and changes in the described structures and methods of assembly and operation can be practiced without meaningfully departing from the principles, spirit, and scope of this disclosure, as set forth in the following claims and their equivalents.

What is claimed is:

1. An oxygen absorbing element comprising a sealed sachet containing an oxygen absorbing composition, wherein the oxygen absorbing composition comprises iron and carbon.

2. The oxygen absorbing element of claim 1, wherein the oxygen absorbing composition further comprises glycerin and zeolite.

3. The oxygen absorbing element of claim 2, wherein the oxygen absorbing composition further comprises salt and water.

4. The oxygen absorbing element of claim 3, wherein the oxygen absorbing composition comprises about 30-50% by weight of iron, about 5-20% by weight of zeolite, about 5-10% by weight of glycerin, about 5-25% by weight of carbon, about 3-7% by weight of salt, and about 4-20% by weight of water.

5. The oxygen absorbing element of claim 3, wherein the salt comprises at least one selected from among sodium chloride (NaCl), potassium chloride (KCl), sodium nitrate (NaNO₃), potassium sulfate (KS₂O₄), and potassium perchlorate (KClO₄).

6. The oxygen absorbing element of claim 1, wherein the carbon comprises at least one selected from among lignite carbon and 325 mesh carbon.

7. The oxygen absorbing element of claim 1, wherein the iron comprises at least one selected from among sponge iron and 325 mesh iron.

8. The oxygen absorbing element of claim 2, wherein the glycerin is a liquid glycerin.

9. The oxygen absorbing element of claim 4, wherein the oxygen absorbing composition comprises about 50% by weight of iron, about 5% by weight of glycerin, about 25% by weight of zeolite, and about 20% by weight of carbon.

10. The oxygen absorbing element of claim 1, wherein the oxygen absorbing composition further comprises diatomaceous earth.

11. The oxygen absorbing element of claim 10, wherein the oxygen absorbing composition further comprises salt and water.

12. The oxygen absorbing element of claim 11, wherein the oxygen absorbing composition comprises about 30-50%% by weight of iron, about 10-30% by weight of diatomaceous earth, about 5-20% by weight of carbon, about 3-7% by weight of salt, and about 4-20% by weight of water.

13. A method for manufacturing an oxygen absorbing element comprising a sealed sachet using a packaging machine comprising a container and a turntable, the method comprising:
preparing an oxygen absorbing composition;
adding the oxygen absorbing composition to the container over a turntable, the container being configured to deposit a measured amount of the oxygen absorbing composition;
depositing the oxygen absorbing composition into a sachet on the turntable using the container;
depositing water to the oxygen absorbing composition in the sachet using a water pump; and
sealing the sachet using the packaging machine.

14. The method of claim 13, wherein the oxygen absorbing composition comprises iron, carbon, glycerin, and zeolite.

15. The method of claim 14, wherein the oxygen absorbing composition further comprises salt.

16. The method of claim 14, wherein the oxygen absorbing composition comprises about 50% by weight of iron, about 5% by weight of glycerin, about 25% by weight of zeolite, and about 20% by weight of carbon.

17. The method of claim 13, wherein an amount of water deposited is 0-20% by weight of the oxygen absorbing composition.

18. The method of claim 17, wherein an amount of water deposited is 14-20% by weight of the oxygen absorbing composition.

19. The method of claim 14, wherein the glycerin is a liquid glycerin.

20. The method of claim 19, wherein the liquid glycerin is added to the iron before they are added to the carbon and the zeolite of the oxygen absorbing composition.

21. The method of claim 14, wherein the iron is added to the zeolite before they are added to the glycerin and carbon.

22. The method of claim 13, wherein the oxygen absorbing composition comprises iron, carbon, and diatomaceous earth.

23. The method of claim 22, wherein the oxygen absorbing composition comprises about 5-20% by weight of diatomaceous earth, about 35-50% by weight of carbon, and about 25% by weight of iron.

24. An oxygen absorbing composition comprising about 30-50% by weight of iron, about 5-20% by weight of Zeolite, about 5-10% by weight of glycerin, about 5-25% by weight of carbon, about 3-7% by weight of salt, and about 4-20% by weight of water.
